(19) United States
(12) Patent Application Publication
(10) Pub. No.: US 2022/0352672 A1
(43) Pub. Date: Nov. 3, 2022

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Junichi MUKUNO, Mie (JP)

(21) Appl. No.: 17/634,091

(22) PCT Filed: Aug. 18, 2020
(86) PCT No.: PCT/JP2020/031088

§ 371 Date: Feb. 9, 2022

(30) Foreign Application Priority Data
Aug. 30, 2019 (JP) 2019-157785

(51) Int. Cl. H01R 13/533

(52) U.S. Cl. CPC H01R 13/533; H01R 2201/26

(57) ABSTRACT

Provided is a connector with which heat dissipation performance can be improved while suppressing any increase in size. A connector 10 comprises: a connector housing 11; and terminals T that are accommodated in the connector housing 11 and electrically connected to a counterpart device. The connector housing 11 includes top-side inclined surface sections 41a, 41b that are inclined relative to the horizontal direction, in a state of being attached to the counterpart device, at positions on the top side in the vertical direction with respect to the terminals T. Also provided are top-side ventilation films 44a that are disposed to the top-side inclined surface parts 41a, 41b and are air permeable with respect to top-side through holes 43a, 43b.

### TECHNICAL FIELD

The present disclosure relates to a connector.

### BACKGROUND

Conventionally, a connector designed to be mounted on a mating device is known (see, for example, Patent Document 1). In such a connector, a part of a wire is inserted into a housing and a core of the wire is electrically connected to an inner conductor and a terminal in the housing. The terminal of the shield connector contacts the mating device or a terminal in a mating connector, whereby the core is electrically connected to the mating device or the terminal in the mating connector.

### PRIOR ART DOCUMENT

### Patent Document

Patent Document 1: WO 2015/060113 A1

### SUMMARY OF THE INVENTION

### Problems to be Solved

In the shield connector as described above, heat generated in the terminal and the inner conductor in the housing is mainly transferred to the wire. On the other hand, in a shield connector used in a hybrid vehicle, an electric vehicle or the like, an amount of heat generation increases since a large current is supplied to a device to be connected. Thus, to improve dissipation performance, it is necessary to enlarge a terminal and an inner conductor and enlarge a diameter of a wire, whereby there is a concern that the shield connector itself is also enlarged.

The present disclosure aims to provide a connector capable of improving dissipation performance while suppressing enlargement.

### Means to Solve the Problem

The present disclosure is directed to a connector with a connector housing and a terminal to be accommodated into the connector housing and electrically connected to a mating device, wherein the connector housing includes an upper slope portion inclined with respect to a horizontal direction at a position vertically above the terminal in a state mounted on the mating device, and a breathable upper breathable film is provided in an upper through hole provided in the upper slope portion.

### Effect of the Invention

According to the connector of the present disclosure, it is possible to improve dissipation performance while suppressing enlargement.

### BRIEF DESCRIPTION OF THE DRAWINGS

FIG. 1 is a perspective view of a connector in one embodiment.

FIG. 2 is a front view of the connector in the embodiment.

FIG. 3 is a section along 3-3 in FIG. 2.

FIG. 4 is a section along 4-4 in FIG. 2.

FIG. 5 is a section along 5-5 in FIG. 3.

FIG. 6 is a section along 6-6 in FIG. 3.

### DETAILED DESCRIPTION TO EXECUTE THE INVENTION

### Description of Embodiments of Present Disclosure

First, embodiments of the present disclosure are listed and described.

[1] The connector of the present disclosure includes a connector housing and a terminal to be accommodated into the connector housing and electrically connected to a mating device, wherein the connector housing includes an upper slope portion inclined with respect to a horizontal direction at a position vertically above the terminal in a state mounted on the mating device, and a breathable upper breathable film is provided in an upper through hole provided in the upper slope portion.

According to this configuration, dissipation performance can be enhanced while enlargement is suppressed since heat generated in and around the terminal can be dissipated to outside through the upper breathable film provided in the upper slope portion.

[2] Preferably, the connector housing includes a lower through hole at a position vertically below the terminal in the state mounted on the mating device, and a breathable lower breathable film is provided in a lower through hole.

According to this configuration, dissipation performance can be improved by promoting the occurrence of natural convection of air by including the lower breathable film in addition to the upper breathable film.

[3] Preferably, the upper and lower breathable films are arranged to face at least the terminal.

According to this configuration, since the terminal, which easily generates heat, and the respective breathable films are arranged to face each other, heat generated from the terminal can be immediately dissipated.

[4] Preferably, the upper slope portion includes a first upper slope portion inclined downward from a central part to one outer side of the connector housing and a second upper slope portion inclined downward from the central part to the other outer side of the connector housing, and upper end parts of the first and second upper slope portions are connected to form a V shape, and each of the first and second upper slope portions includes an extending wall portion extending from a lower end part.

According to this configuration, foreign matters such as dust and water can be made hard to stay in the lower ends of the respective slope portions and the adhesion of foreign matters to the upper breathable film can be suppressed by including the extending wall portions extending from the lower end parts of the first and second upper slope portions.

[5] Preferably, the extending wall portions are slopes continuous from and having the same angle of inclination as the first and second upper slope portions.

According to this configuration, since the extending wall portions are slopes continuous from and having the same angle of inclination as the first and second upper slope portions, foreign matters such as dust and water can be made hard to stay in the lower ends of the respective slope portions and the adhesion of foreign matters to the upper breathable film can be suppressed.

[6] Preferably, the connector housing includes a lower slope portion inclined with respect to the horizontal direction at a position vertically below the terminal in the state mounted on the mating device, the lower slope portion includes a first lower slope portion inclined downward from one outer side to a central part of the connector housing and a second lower slope portion inclined downward from the other outer side to the central part of the connector housing, and lower end parts of the first and second lower slope portions are connected to form a V shape, and the lower slope portion includes a lower extending portion extending downward from lower end parts of the first and second lower end parts.

According to this configuration, foreign matters such as dust and water can be made hard to stay in the lower ends of the first and second lower slope portions and the adhesion of foreign matters to the lower breathable film can be suppressed by including the lower extending portion extending downward from the lower end parts of the first and second lower slope portions.

### Details of Embodiment of Present Disclosure

A specific example of a connector of the present disclosure is described below with reference to the drawings. In each figure, some of components may be shown in an exaggerated or simplified manner for the convenience of description. Further, a dimension ratio of each part may be different in each figure. Note that the present invention is not limited to these illustrations and is intended to be represented by claims and include all changes in the scope of claims and in the meaning and scope of equivalents. “Parallel”, “orthogonal” and “horizontal” in this specification mean not only strictly parallel, orthogonal and horizontal, but also substantially parallel, orthogonal and horizontal within a range in which functions and effects in this embodiment are achieved.

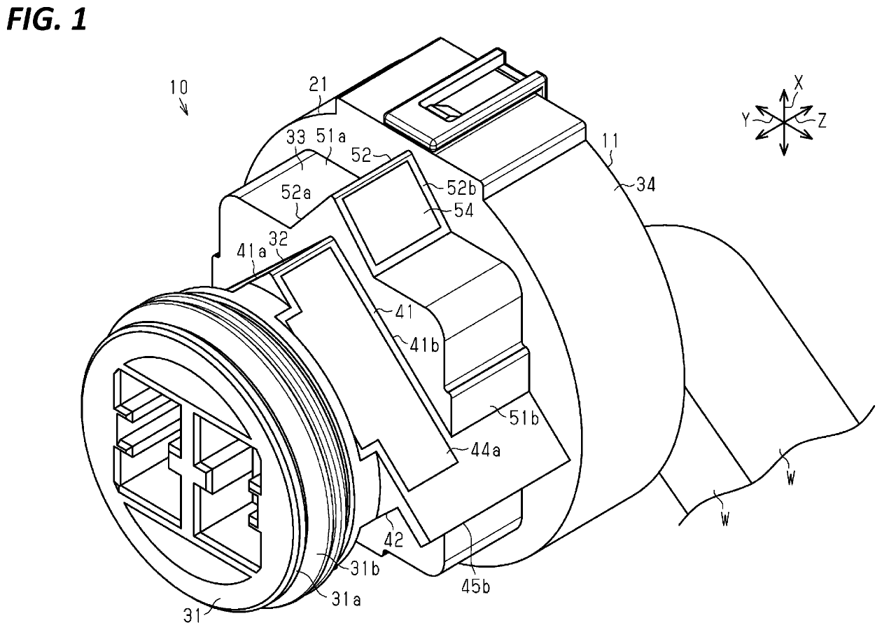

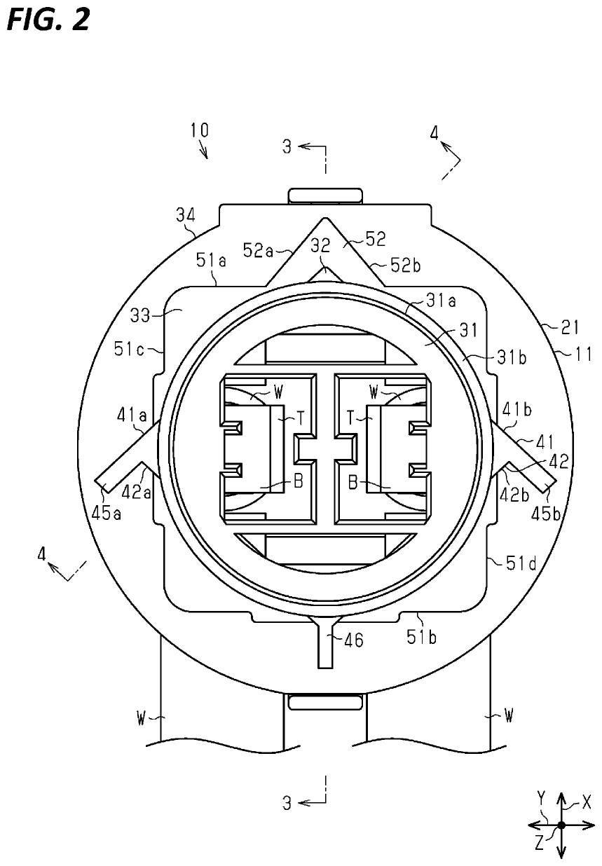

A connector 10 shown in FIGS. 1 and 2 is for connecting two wires W extending in parallel to each other to a mating device (not shown). Note that a motor, an inverter and the like installed in a hybrid vehicle, an electric vehicle or the like can be, for example, cited as the mating device. Note that, in the following description, an up-down direction in FIG. 2 is referred to as an up-down direction X, a lateral direction in FIG. 2 is referred to as a lateral direction Y and a direction orthogonal to the plane of FIG. 2 is referred to as a front-rear direction Z.

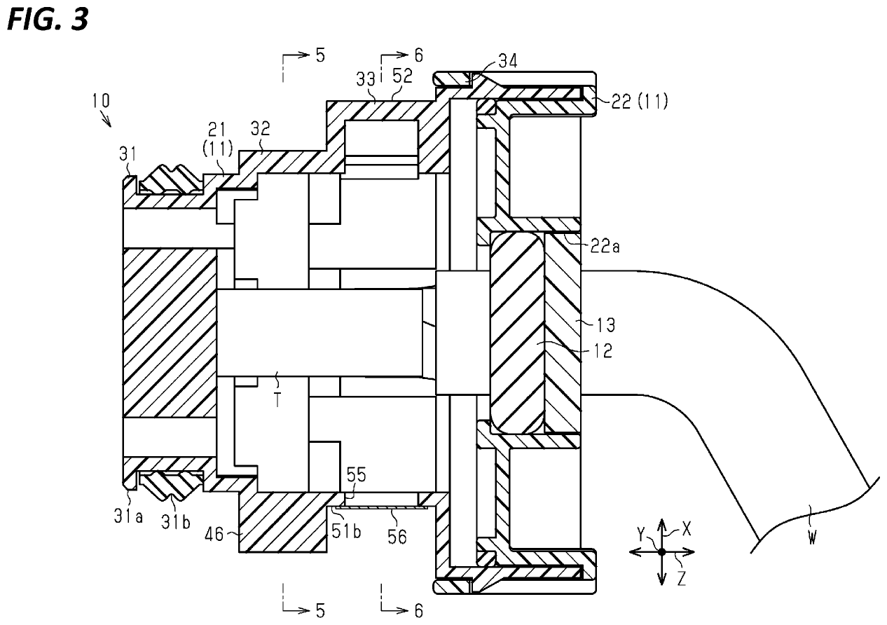

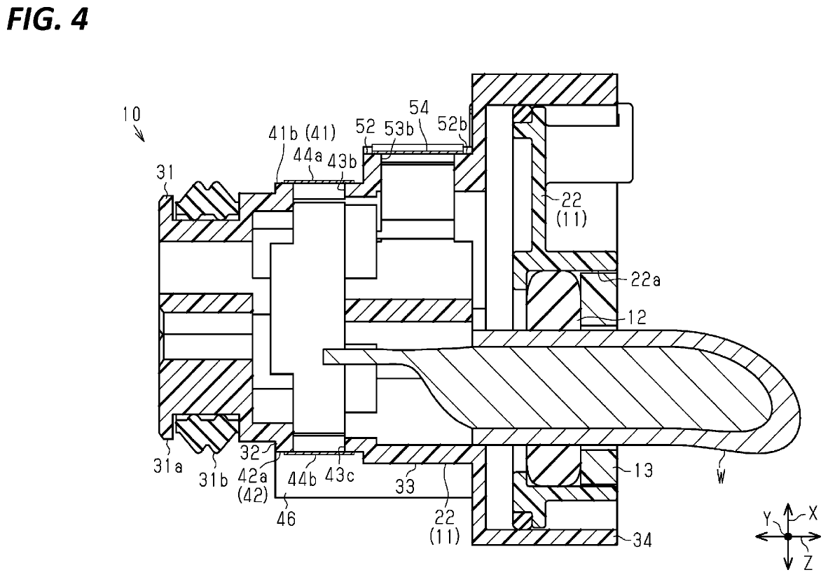

As shown in FIGS. 3 and 4, the connector 10 includes a connector housing 11 made of synthetic resin and configured to accommodate end parts of the two wires W, sealing members 12 for sealing between each wire W and the connector housing 11, and a retainer 13 for retaining the respective sealing members 12. The retainer 13 is locked to the connector housing 11.

The connector housing 11 includes a front housing 21 and a rear housing 22. The front housing 21 is located on a front side in the front-rear direction Z with respect to the rear housing 22. Note that, in this example, a forward direction in the front-rear direction Z is a mounting direction of the connector 10 on the mating device.

The front housing 21 is configured into a tubular shape. The rear housing 22 is mounted on a rear part of the front housing 21. The rear housing 22 includes inserting portions 22a into which the wires W are insertable. The sealing member 12 for sealing between the wire W and the inserting portion 22a is provided in the inserting portion 22a. Further, the retainer 13 is mounted behind the sealing members 12 in the inserting portions 22a.

The end parts, as parts of the two wires W, are accommodated into the connector housing 11. A terminal T is electrically connected to the end part of each wire W via a busbar B, which is an inner conductive member. Note that the terminals T electrically connected to the respective wires W are provided side by side in the lateral direction Y. Here, the lateral direction Y, in which the terminals T are arranged, is a direction parallel to a horizontal direction in a state mounted on the mating device. In other words, the lateral direction Y, in which the terminals T are arranged, is a direction orthogonal to a vertical direction in the state mounted on the mating direction.

The front housing 21 includes a first hollow cylindrical portion 31, a first rectangular tube portion 32, a second rectangular tube portion 33 and a second hollow cylindrical portion 34 in this order from a tip side to be connected to the mating device, i.e. from a front side in the front-rear direction Z.

The first hollow cylindrical portion 31 is configured into a hollow cylindrical shape and connected to the mating device. A sealing member 31b in the form of a circular ring is mounted on an outer peripheral part 31a of the first hollow cylindrical portion 31 to seal between the mating device and the first hollow cylindrical portion 31 in a state inserted in the mating device.

The second hollow cylindrical portion 34 is configured into a hollow cylindrical shape and has a larger diameter than the first hollow cylindrical portion 31. The second hollow cylindrical portion 34 accommodates the rear housing 22, the sealing members 12 and the retainer 13 inside.

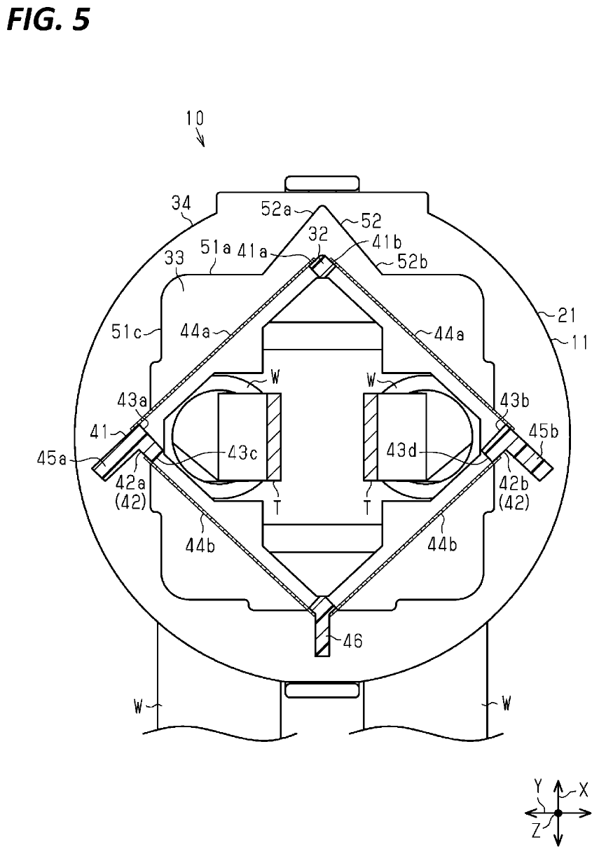

As shown in FIG. 5, the first rectangular tube portion 32 includes an upper slope portion 41 inclined with respect to the horizontal direction at a position vertically above the terminals T in the state mounted on the mating device and a lower slope portion 42 inclined with respect to the horizontal direction at a position vertically below the terminals T in the state mounted on the mating device.

The upper slope portion 41 includes a first upper slope portion 41a inclined downward from a central part to one outer side in the lateral direction Y of the connector housing 11 and a second upper slope portion 41b inclined downward from the central part to the other outer side in the lateral direction Y of the connector housing 11. The upper slope portion 41 is configured into a V shape projecting vertically upward by the first and second upper slope portions 41a, 41b. The first and second upper slope portions 41a, 41b are, as an example, inclined by 45° with respect to the vertical direction and the horizontal direction with the connector 10 mounted on the mating device. Note that this angle is an example and can be changed as appropriate.

The lower slope portion 42 includes a first lower slope portion 42a inclined downward from one outer side in the lateral direction Y to the central part of the connector housing 11 and a second lower slope portion 42b inclined downward from the other outer side in the lateral direction Y to the central part of the connector housing 11. The lower slope portion 42 is configured into a V shape projecting vertically downward by the first and second lower slope portions 42a, 42b. The first and second lower slope portions 42a, 42b are, as an example, inclined by 45° with respect to the vertical direction and the horizontal direction with the connector 10 mounted on the mating device. Note that this angle is an example and can be changed as appropriate.

As shown in FIG. 5, the first rectangular tube portion 32 includes through holes 43a, 43b, 43c and 43d respectively in the first upper slope portion 41a, the second upper slope portion 41b, the first lower slope portion 42a and the second lower slope portion 42b. The through hole 43a is provided in the first upper slope portion 41a and penetrates in a direction orthogonal to the first upper slope portion 41a. The through hole 43b is provided in the second upper slope portion 41b and penetrates in a direction orthogonal to the second upper slope portion 41b. The through hole 43c is provided in the first lower slope portion 42a and penetrates in a direction orthogonal to the first lower slope portion 42a. The through hole 43d is provided in the second lower slope portion 42b and penetrates in a direction orthogonal to the second lower slope portion 42b. The respective through holes 43a, 43b, 43c and 43d are facing the terminals T in radial directions.

Each of the through holes 43a, 43b is provided with a breathable film 44a. Each of the through holes 43c, 43d is provided with a breathable film 44b. The breathable films 44a, 44b have a property of allowing the passage of gases such as air and restricting the passage of foreign matters such as liquids and dust. The materials and structures of the breathable films 44a, 44b are not particularly limited and known ones can be used as appropriate.

Further, the first and second upper slope portions 41a, 41b of this embodiment respectively include extending wall portions 45a, 45b extending from lower end parts. The extending wall portion 45a is a slope continuous from and having the same angle of inclination as the first upper slope portion 41a. Note that the lower end parts of the first and second upper slope portions 41a, 41b are boundary parts to the first and second lower slope portions 42a, 42b.

Further, the first and second lower slope portions 42a, 42b of this embodiment respectively include a lower extending portion 46 extending downward from lower end parts, i.e. a boundary part between the first and second slope portions 42a, 42b. The lower extending portion 46 extends along the vertical direction with the connector 10 mounted on the mating device.

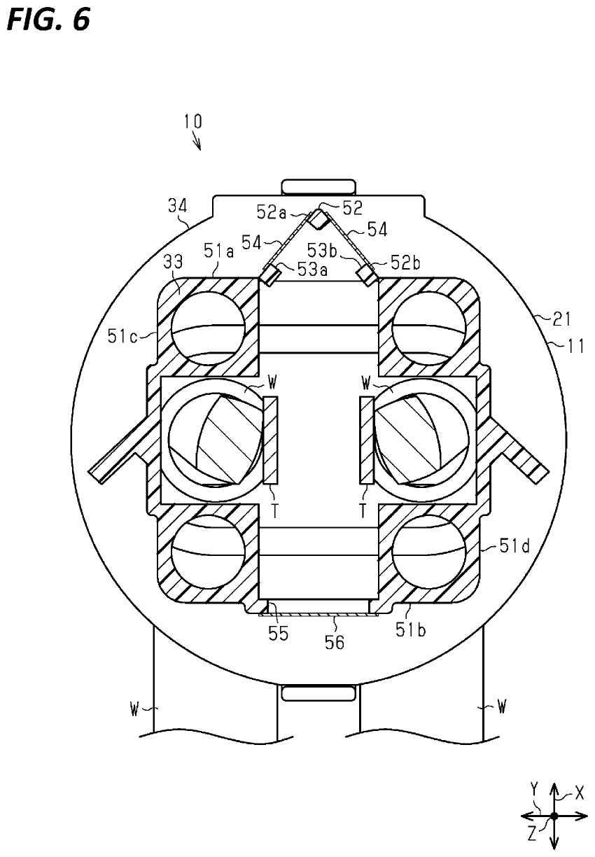

As shown in FIG. 6, the second rectangular tube portion 33 is configured into a rectangular tube shape. The second rectangular tube portion 33 has four outer side surfaces 51a, 51b, 51c and 51d facing outward. The outer side surfaces 51a, 51b are facing in the up-down direction X, and the outer side surfaces 51c, 51d are facing in the lateral direction Y. The outer side surfaces 51a, 51b are surfaces parallel to a direction (horizontal direction) orthogonal to the vertical direction with the connector 10 mounted on the mating device. The outer side surfaces 51c, 51d are surfaces parallel to a direction (vertical direction) orthogonal to the horizontal direction with the connector 10 mounted on the mating device.

The outer side surface 51a facing upward in the up-down direction X is located vertically above the terminals T with the connector 10 mounted on the mating device. The outer side surface 51a is provided with a protrusion 52 triangular in a front view.

As shown in FIG. 6, the protrusion 52 has two slope portions 52a, 52b inclined with respect to the horizontal direction at positions vertically above the terminals T with the connector 10 mounted on the mating device. The slope portion 52a is inclined downward from the central part to one outer side in the lateral direction Y of the connector housing 11, and the slope portion 52a is inclined downward from the central part to the other outer side in the lateral direction Y of the connector housing 11. The protrusion 52 is configured into a V shape projecting vertically upward by the slope portions 52a, 52b. Angles of inclination of the slope portions 52a, 52b with respect to the horizontal direction may be equal to or different from those of the upper slope portions 41a, 41b.

The slope portions 52a, 52b respectively have through holes 53a, 53b. The through hole 53a is provided in the slope portion 52a and penetrates in a direction orthogonal to the slope portion 52a. The through hole 53b is provided in the slope portion 52b and penetrates in a direction orthogonal to the slope portion 52b. Each of the through holes 53a, 53b is provided with a breathable film 54. The breathable films 54 have a property of allowing the passage of gases such as air and restricting the passage of foreign matters such as liquids and dust. The materials and structures of the breathable films 54 are not particularly limited and known ones can be used as appropriate. The materials and structures of the breathable films 54 may be the same as or different from those of the breathable films 44a, 44b.

The outer side surface 51b facing downward in the up-down direction X is located vertically below the terminals T with the connector 10 mounted on the mating device and is a surface parallel to the horizontal direction. The outer side surface 51b includes a through hole 55 penetrating in an orthogonal direction.

As shown in FIGS. 3 and 6, a breathable film 56 is provided in the through hole 55. The breathable film 56 has a property of allowing the passage of gases such as air and restricting the passage of foreign matters such as liquids and dust. The material and structure of the breathable film 56 are not particularly limited and known ones can be used as appropriate. The material and structure of the breathable films 56 may be the same as or different from those of the breathable films 44a, 44b and 54.

Functions of this embodiment are described.

The connector 10 of this embodiment is electrically connected to the mating device by being mounted on the mating device to bring the terminals T thereof into contact with the terminals of the mating device. If a current is supplied to the wires W and the terminals T in this state, heat is generated in the terminals T and the terminals of the mating device. The generated heat is dissipated through the breathable films 44a, 54 located above the terminals T. On the other hand, outside air is taken in through the breathable films 44b, 56 located below the terminals T. By providing the breathable films 44a, 54, 44b and 56 above and below the terminals T in this way, the occurrence of natural convection of air is promoted and heat is efficiently dissipated.

The breathable films 44a are provided in the first and second upper slope portions 41a, 41b, and the breathable films 54 are provided in the slope portions 52a, 52b. Thus, foreign matters such as water and dust are suppressed from staying in the breathable films 44a, 54.

Effects of this embodiment are described.

(1) Dissipation performance can be enhanced while enlargement is suppressed since heat generated in and around the terminals T can be dissipated to outside through the breathable films 44a provided in the upper slope portions 41a, 41b. Further, foreign matters such as water and dust are suppressed from staying in the breathable films 44a since the breathable films 44a are provided in the first and second upper slope portions 41a, 41b.

(2) Dissipation performance can be improved by promoting the occurrence of natural convection of air by including the lower breathable films 44b in addition to the upper breathable films 44a.

(3) Since the terminals T, which easily generated heat, and the respective breathable films 44a, 44b are arranged to face each other, heat generated from the terminals T can be immediately dissipated.

(4) Foreign matters such as water and dust are suppressed from staying in the lower ends of the respective slope portions 41a, 41b and the adhesion of foreign matters to the upper breathable films 44a can be suppressed by including the extending wall portions 45a, 45b extending from the lower end parts of the first and second upper slope portions 41a, 41b.

(5) Since the extending wall portions 45a, 45b are slopes continuous from and having the same angle of inclination as the first and second upper slope portions 41a, 41b, foreign matters such as water and dust can be made hard to stay in the lower ends of the respective slope portions 41a, 41b and the adhesion of foreign matters to the upper breathable films 44a can be suppressed.

(6) Foreign matters such as water and dust are suppressed from staying in the lower ends of the first and second lower slope portions 42a, 42b and the adhesion of foreign matters to the lower breathable films 44b can be suppressed by including the lower extending portion 46 extending downward from the lower end parts of the first and second lower slope portions 42a, 42b.

(7) Dissipation performance can be further enhanced by including the breathable films 54, 56 in addition to the breathable films 44a, 44b. Further, since the breathable films 54 are provided in the slope portions 52a, 52b inclined similarly to the breathable films 44a, the adhesion of foreign matters to the breathable films 54 can be suppressed.

### OTHER EMBODIMENTS

Note that the above embodiment can be modified and carried out as follows. The above embodiment and the following modifications can be carried out in combination without technically contradicting each other.

Although the breathable films 44a, 44b, 54 and 56 are provided in the above embodiment, there is no limitation to this. A configuration from which the breathable films other than the breathable films 44a are omitted may be, for example, adopted. Further, instead of omitting all the breathable films 44b, 54 and 56 other than the breathable films 44a, only the breathable films 44b may be, for example, omitted or the breathable films 54, 56 may be omitted. That is, the breathable films other than the breathable films 44a can be changed as appropriate.

Although the lower extending portion 46 is provided in the above embodiment, the lower extending portion 46 may be omitted.

Although the extending wall portions 45a, 45b are slopes having the same angle of inclination as the upper slope portions 41a, 41b in the above embodiment, the angles of inclination thereof may be changed as appropriate.

Although the extending wall portions 45a, 45b are provided in the above embodiment, at least one of the extending wall portions 45a, 45b may be omitted.

Although the terminals T and the respective breathable films 44a, 44b are arranged to face each other in the above embodiment, these need not necessarily be arranged to face each other. For example, the breathable films 44a, 44b may be arranged while being shifted from the terminals T in the front-rear direction. Further, only either the breathable films 44a or the breathable films 44b may be arranged to face the terminals T and the other breathable films 44a, 44b may be arranged while being shifted from the terminals T.

Although the lower slope portions 42a, 42b are provided with the breathable films 44b in the above embodiment, there is no limitation to this. For example, the breathable films 44b may be provided other than in slopes inclined with respect to the horizontal direction, i.e. provided in surfaces parallel to the horizontal direction.

Although not particularly mentioned in the above embodiment, the terminals T may be male terminals or female terminals.

Although the connector 10 is a non-shield connector including no electromagnetic shield in the above embodiment, the connector 10 may be a shield connector including an electromagnetic shield fixedly provided inside or outside the connector housing 11.

As shown in FIG. 2, when the connector 10 is viewed from the front-rear direction Z, the protrusion 52, the lower extending portion 46 and the extending wall portions 45a, 45b may be configured to be accommodated radially inwardly of the second hollow cylindrical portion 34. According to this, opening areas of the through holes 43a, 43b, 43c and 43d, i.e. ventilation areas can be increased while the enlargement of the connector 10 is suppressed, whereby a size reduction of the connector 10 and an improvement of a dissipation effect can be combined.

### LIST OF REFERENCE NUMERALS

B busbar
T terminal
W wire
X up-down direction
Y lateral direction
Z front-rear direction
10 connector
11 connector housing
12 sealing member
13 retainer
21 front housing
22 rear housing
22a inserting portion
31 first hollow cylindrical portion
31a outer peripheral part
31b sealing member
32 first rectangular tube portion
33 second rectangular tube portion
34 second hollow cylindrical portion
41 upper slope portion
41a first upper slope portion
41b second upper slope portion
42 lower slope portion
42a first lower slope portion
42b second lower slope portion
43a, 43b, 43c, 43d through hole
44a breathable film (upper breathable film)
44b breathable film (lower breathable film)
45a, 45b extending wall portion
46 lower extending portion
51a, 51b, 51c, 51d outer side surface
52 protrusion
52a, 52b slope portion
53a, 53b through hole
54 breathable film
55 through hole
56 breathable film

1. A connector, comprising:
a connector housing; and
a terminal to be accommodated into the connector housing and electrically connected to a mating device,
wherein:
the connector housing includes an upper slope portion inclined with respect to a horizontal direction at a position vertically above the terminal in a state mounted on the mating device, and
a breathable upper breathable film is provided in an upper through hole provided in the upper slope portion.

2. The connector of claim 1, wherein:
the connector housing includes a lower through hole at a position vertically below the terminal in the state mounted on the mating device, and
a breathable lower breathable film is provided in a lower through hole.

3. The connector of claim 2, wherein the upper and lower breathable films are arranged to face at least the terminal.

4. The connector of claim 1, wherein:
the upper slope portion includes a first upper slope portion inclined downward from a central part to one outer side of the connector housing and a second upper slope portion inclined downward from the central part to the other outer side of the connector housing, and upper end parts of the first and second upper slope portions are connected to form a V shape, and
each of the first and second upper slope portions includes an extending wall portion extending from a lower end part.

5. The connector of claim 4, wherein the extending wall portions are slopes continuous from and having the same angle of inclination as the first and second upper slope portions.

6. The connector of claim 1, wherein:
the connector housing includes a lower slope portion inclined with respect to the horizontal direction at a position vertically below the terminal in the state mounted on the mating device,
the lower slope portion includes a first lower slope portion inclined downward from one outer side to a central part of the connector housing and a second lower slope portion inclined downward from the other outer side to the central part of the connector housing, and lower end parts of the first and second lower slope portions are connected to form a V shape, and
the lower slope portion includes a lower extending portion extending downward from lower end parts of the first and second lower end parts.
